(19) United States
(12) Patent Application Publication
(10) Pub. No.: US 2011/0093266 A1
(43) Pub. Date: Apr. 21, 2011

(54) VOICE PATTERN TAGGED CONTACTS

(76) Inventor: Krister Tham, Lund (SE)

(21) Appl. No.: 12/579,502

(22) Filed: Oct. 15, 2009

(51) Int. Cl. G10L 15/00

(52) U.S. Cl. 704/246

(57) ABSTRACT

A method and system for associating a voice pattern with a contact record and/or for identifying a speaker using a mobile device. A mobile device may include a voice identification application for extracting a voice pattern from audio data and associating the voice pattern with a contact record that includes identification information such as, for example, a name of a person. The device may also be used to identify a speaker. The device captures audio data of a speaker; the voice identification application extracts a voice pattern from the audio data and compares the voice pattern to voice patterns associated with contact records stored in a contact directory. The voice identification application identifies a contact record having a voice pattern matching the voice pattern from the audio data and drives the device to display identification information from the contact record having a matching voice pattern.

### TECHNICAL FIELD OF THE INVENTION

The present invention relates to identifying individuals by voice patterns. More particularly, the invention relates to a system and method for associating voice patterns with contact records and/or obtaining identification information about a speaker using such contact records.

### DESCRIPTION OF THE RELATED ART

When an incoming call is received by a mobile telephone, the caller ID is automatically presented on the phone display. The caller ID may include identification information such as a name and/or picture associated with a contact record related to the calling number.

### SUMMARY

According to one aspect of the invention, a method of operating a mobile device to obtain and associate audio data with a contact record, the method comprises obtaining audio data containing a voice signal; extracting a voice pattern from the audio data; and associating the voice pattern with a contact record, the contact record including identification information identifying a person.

In one embodiment, the identification information includes a person's name.

In one embodiment, obtaining the audio data comprises operating the device to record a person speaking.

In one embodiment, the mobile device comprises a telephone application for placing and receiving telephone calls, and obtaining the audio comprises operating the device to record audio data that is received by the device during a telephone call.

In one embodiment, a contact record identifying a contact associated with the telephone number called by or calling the device is activated during the telephone call, and the extracted voice pattern is automatically associated with the contact record.

In one embodiment, the method comprises a user tagging a segment of the audio data to create an audio clip, and a voice pattern is extracted from the audio clip.

In one embodiment, associating the voice pattern with a contact record comprises user selection of a contact record and user input directing the device to associate the voice pattern with the selected identification file.

According to another aspect of the invention, a mobile device comprises a contact directory storing a plurality of contact records, each contact record including identification information relating to a person; and a voice identification application, the voice identification application, when executed, causes the device to extract a voice pattern from audio data and associate the voice pattern with a contact record.

In one embodiment, the mobile device comprises a network communication system; a user interface; and a telephone application for placing and receiving telephone calls via the network communication system, wherein the device records audio data received by the device during a telephone call and the voice identification application extracts a voice pattern from the recorded audio data.

In one embodiment, the telephone application drives the user interface to display a contact record when a caller ID signal of an incoming or outgoing call matches a telephone number in the contact record, and the voice identification application (i) drives the user interface to request user input to associate the extracted voice pattern with the contact record, or (ii) automatically associates the voice pattern with the contact record.

In one embodiment, a contact record has a plurality of voice patterns associated therewith.

In one embodiment, the voice identification application extracts a voice pattern from a user selected segment of audio data defining an audio clip.

According to still another aspect of the invention, a method of operating a mobile device to identify a speaker comprises obtaining audio data containing a voice signal; extracting a voice pattern from the audio data; comparing the extracted voice pattern from the audio data to voice patterns associated with contact records stored in a contact directory, each contact record including identification information identifying a person; identifying a contact record having a voice pattern associated therewith that matches the voice pattern extracted from the obtained audio data; and displaying, on a display of the mobile device, identification information associated with the identified contact record. In one embodiment, the mobile device is a mobile telephone.

In one embodiment, obtaining audio data comprises continuously capturing audio data received by the device, and the displaying operation comprises continuously updating the display with identification information indicative of a current speaker.

In one embodiment, the contact directory is stored on the mobile device.

In one embodiment, the contact directory is stored on a remote directory server.

In one embodiment, capturing audio data includes continuously capturing audio data received by the device and continuously updating the display to display identification information indicative of a current speaker.

In one embodiment, the method includes a user tagging a segment of audio data to create an audio clip from which a voice pattern is extracted for comparison to voice patterns associated with the contact records.

In still a further aspect of the invention, a mobile device comprises a sound signal processing circuit for receiving and playing audio data; a voice identification application that executes logic including code that: extracts a voice pattern from audio data; accesses a to contact directory storing a plurality of contact records, each contact record including identification information identifying with a person, the identification information including a voice pattern and a name of the person; identify a contact record from the contact directory having a voice pattern that matches a voice pattern of the audio data; and drive the user interface to display at least a portion of the identification information from the selected contact record. In one embodiment, the device is a mobile telephone.

In one embodiment, the contact directory is located on a remote directory server, and the voice identification application accesses the remote directory server via a network communication system.

In one embodiment, the contact directory is resident on the mobile device.

In one embodiment, the voice identification application is activated by a user command.

In one embodiment, the voice identification application is operated in a continuous mode, and operates to continuously update the display to display identification information indicative of a current speaker.

In one embodiment, a contact record comprises a plurality of voice patterns.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic illustration of an exemplary mobile device suitable for use in accordance with aspects of the present invention;

FIG. 2 is a diagrammatic illustration of components of the mobile device of FIG. 1;

FIG. 3 is a flow chart illustrating exemplary operation of a device and voice identification application for associating audio video with a contact record;

FIG. 4 is a flow chart illustrating another exemplary operation of a device and voice identification application for associating audio data with a contact record;

FIG. 5 is a flow chart illustrating still another exemplary operation of a device and voice identification application for associating audio video with a contact record;

FIG. 6 is a flow chart illustrating an exemplary operation of a device and voice identification application for determining the identity of a speaker; and

FIG. 7 is a schematic illustration of a web-based infrastructure on which aspects of the present invention may be carried out.

### DETAILED DESCRIPTION OF EMBODIMENTS

Embodiments will now be described with reference to the drawings, wherein like reference numerals are used to refer to like elements throughout.

The term “electronic equipment” includes portable radio communication equipment. The term “portable radio communication equipment,” which may also be referred to herein as a “mobile radio terminal,” includes all equipment such as mobile telephones, pagers, communicators, i.e., electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of electronic equipment.

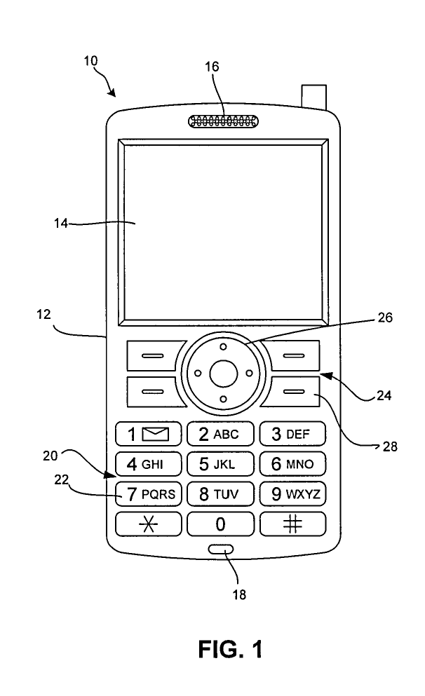

Referring to FIG. 1, an electronic device 10 suitable for use with the disclosed methods and applications is shown. The electronic device 10 in the exemplary embodiment is shown as a portable network communication device, e.g., a mobile telephone, and will be referred to as the mobile telephone 10. The mobile telephone 10 is shown as having a “brick” or “block” design type housing, but it will be appreciated that other type housings, such as clamshell housing or a slide-type housing, may be utilized without departing from the scope of the invention.

As illustrated in FIG. 1, the mobile telephone 10 may include a user interface that enables the user to easily and efficiently perform one or more communication tasks (e.g., enter in text, display text or images, send an E-mail, display an E-mail, receive an E-mail, identify a contact, select a contact, make a telephone call, receive a telephone call, etc.). The mobile phone 10 includes a housing 12, a display 14, a speaker 16, a microphone 18, a keypad 20, and a number of keys 24. The display 14 may be any suitable display, including, e.g., a liquid crystal display, a light emitting diode display, or other display. The keypad 20 comprises a plurality of keys 22 (sometimes referred to as dialing keys, input keys, etc.). The keys 22 in keypad area 20 may be operated, e.g., manually or otherwise to provide inputs to circuitry of the mobile phone 10, for example, to dial a telephone number, to enter textual input such as to create a text message, to create an e-mail, or to enter other text, e.g., a code, pin number, security ID, to perform some function with the device, or to carry out some other function.

The keys 24 may include a number of keys having different respective functions. For example, the key 26 may be a navigation key, selection key, or some other type of key, and the keys 28 may be, for example, soft keys or soft switches. As an example, the navigation key 26 may be used to scroll through lists shown on the display 14, to select one or more items shown in a list on the display 14, etc. The soft switches 28 may be manually operated to carry out respective functions, such as those shown or listed on the display 14 in proximity to the respective soft switch. The display 14, speaker 16, microphone 18, navigation key 26 and soft keys 28 may be used and function in the usual ways in which a mobile phone typically is used, e.g. to initiate, to receive and/or to answer telephone calls, to send and to receive text messages, to connect with and carry out various functions via a network, such as the Internet or some other network, to beam information between mobile phones, etc. These are only examples of suitable uses or functions of the various components, and it will be appreciated that there may be other uses, too.

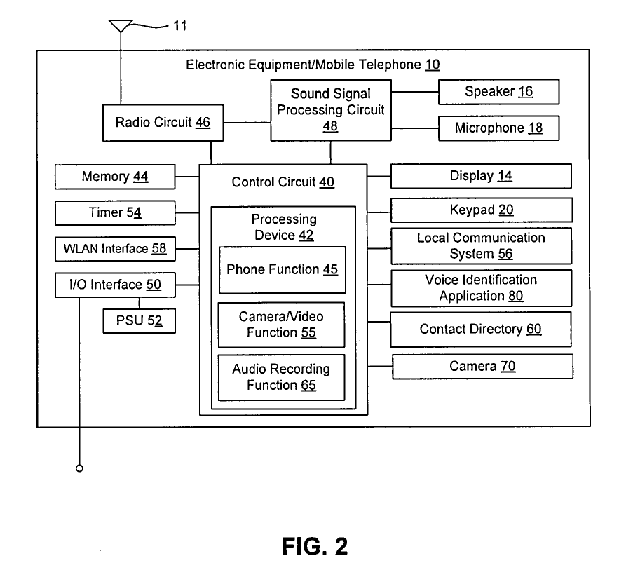

The mobile telephone 10 includes a display 14. The display 14 displays information to a user such as operating state, time, telephone numbers, contact information, various navigational menus, status of one or more functions, etc., which enable the user to utilize the various features of the mobile telephone 10. The display 14 may also be used to visually display content accessible by the mobile telephone 10. The displayed content may include E-mail messages, geographical information, journal information, photographic images, audio and/or video presentations stored locally in memory 44 (FIG. 2) of the mobile telephone 10 and/or stored remotely from the mobile telephone (e.g., on a remote storage device, a mail server, remote personal computer, etc.), information related to audio content being played through the device (e.g., song title, artist name, album title, etc.), and the like. Such presentations may be derived, for example, from multimedia files received through E-mail messages, including audio and/or video files, from stored audio-based files or from a received mobile radio and/or television signal, etc. The displayed content may also be text entered into the device by the user. The audio component may be broadcast to the user with a speaker 16 of the mobile telephone 10. Alternatively, the audio component may be broadcast to the user though a headset speaker (not shown).

The device 10 optionally includes the capability of a touchpad or touch screen. The touchpad may form all or part of the display 14, and may be coupled to the control circuit 40 for operation as is conventional.

Various keys other than those keys illustrated in FIG. 1 may be associated with the mobile telephone 10 may include a volume key, audio mute key, an on/off power key, a web browser launch key, an E-mail application launch key, a camera key to initiate camera circuitry associated with the mobile telephone, etc. Keys or key-like functionality may also be embodied as a touch screen associated with the display 14.

The mobile telephone 10 may also include camera circuitry allowing the telephone to be used as a camera or video recorder. When the phone is operated as a camera or video recorder, the display 14 may function as an electronic view finder to aid the user when taking a photograph or a video clip and/or the display may function as a viewer for displaying saved photographs and/or video clips. In addition, in a case where the display 14 is a touch sensitive display, the display 14 may service as an input device to allow the user to input data, menu selections, etc.

Referring to FIG. 2, a functional block diagram of the mobile telephone 10 is illustrated. The mobile telephone 10 includes a primary control circuit 40 that is configured to carry out overall control of the functions and operations of the mobile telephone 10. The control circuit 40 may include a processing device 42, such as a CPU, microcontroller or microprocessor. The processing device 42 executes code stored in a memory (not shown) within the control circuit 40 and/or in a separate memory, such as memory 44, in order to carry out conventional operation of the mobile telephone function 45.

The memory 44 may be, for example, a buffer, a flash memory, a hard drive, a removable media, a volatile memory and/or a non-volatile memory.

Continuing to refer to FIG. 2, the mobile telephone 10 includes an antenna 11 coupled to a radio circuit 46. The radio circuit 46 includes a radio frequency transmitter and receiver for transmitting and receiving signals via the antenna 11 as is conventional. The mobile telephone 10 generally utilizes the radio circuit 46 and antenna 11 for voice and/or E-mail communications over a cellular telephone network. The mobile telephone 10 further includes a sound signal processing circuit 48 for processing the audio signal transmitted by/received from the radio circuit 46. Coupled to the sound processing circuit 48 are the speaker 16 and the microphone 18 that enable a user to listen and speak via the mobile telephone 10 as is conventional. The microphone also enables a user to use the telephone 10 as a recording device if desired. The radio circuit 46 and sound processing circuit 48 are each coupled to the control circuit 40 so as to carry out overall operation.

The mobile telephone 10 also includes the aforementioned display 14 and keypad 20 coupled to the control circuit 40. The device 10 and display 14 optionally includes the capability of a touchpad or touch screen, which may be all of part of the display 14. The mobile telephone 10 further includes an I/O interface 50. The I/O interface 50 may be in the form of typical mobile telephone I/O interfaces, such as a multi-element connector at the base of the mobile telephone 10. As is typical, the I/O interface 50 may be used to couple the mobile telephone 10 to a battery charger to charge a power supply unit (PSU) 52 within the mobile telephone 10. In addition, or in the alternative, the I/O interface 50 may serve to connect the mobile telephone 10 to a wired personal hands-free adaptor, to a personal computer or other device via a data cable, etc. The mobile telephone 10 may also include a timer 54 for carrying out timing functions. Such functions may include timing the durations of calls and/or events, tracking elapsed times of calls and/or events, generating timestamp information, e.g., date and time stamps, etc.

The mobile telephone 10 may include various built-in accessories. In one embodiment, the mobile telephone 10 also may include a position data receiver, such as a global positioning satellite (GPS) receiver, Galileo satellite system receiver, or the like. The mobile telephone 10 may also include an environment sensor to measure conditions (e.g., temperature, barometric pressure, humidity, etc.) in which the mobile telephone is exposed.

The mobile telephone 10 may include a local communication system 56 to allow for short range communication with another device. The local communication system 56 may also be referred to herein as a local wireless interface adapter. Suitable modules or systems for the local communication system include, but are not limited to, such as a Bluetooth radio, infrared communication module, near field communication module, Wi-Fi, and the like. The local communication system may also be used to establish wireless communication with other locally positioned devices, such as a wireless headset, a computer, etc. In addition, the mobile telephone 10 may also include a wireless local area network (WLAN) interface adapter 58 to establish wireless communication with other locally positioned devices, such as a wireless local area network, wireless access point, and the like. Preferably, the WLAN adapter 58 is compatible with one or more IEEE 802.11 protocols (e.g., 802.11(a), 802.11(b) and/or 802.11(g), etc.) and allows the mobile telephone 10 to acquire a unique address (e.g., IP address) on the WLAN and communicate with one or more devices on the WLAN, assuming the user has the appropriate privileges and/or has been properly authenticated. As used herein, the term “local communication system” encompasses a wireless local area network interface.

The mobile telephone 10 further includes a sound signal processing circuit 48 for processing audio signals by and received from the radio circuit 46. Coupled to the sound processing circuit 48 are a speaker 16 and a microphone 18 that enable a user to listen and speak via the mobile telephone 10 as is conventional. The radio circuit 46 and sound processing circuit 48 are each coupled to the control circuit 40 so as to carry out overall operation. Audio data may be passed from the control circuit 46 to the sound signal processing circuit 48 for playback to the user. The audio data may include, for example, audio data from an audio file stored by the memory 44 and retrieved by the control circuit 40, or received audio data such as in the form of audio data (includes speech or voice data) received from another device during a telephone call, audio data received through the microphone, streaming audio data from a mobile radio service, and the like. The sound processing circuit 48 may include any appropriate buffers, decoders, amplifiers, and so forth.

The local communication system and/or WLAN may be used, for example, to allow the device 10 to discover and connect to remote mobile devices that are within a communication zone. The communication zone may be defined by a region around the mobile device 10 within which the device may establish a communication session using the local communication system 56 and/or WLAN adapter 58. It will be appreciated that the communication need not be a traditional call answer session but may simply include the transmission of information to another device (such as by messaging systems including SMS, MMS, and the like, picture message, etc.)

As shown in FIG. 2, the processing device 42 is coupled to memory 44. Memory 44 stores a variety of data that is used by the processor 42 to control various applications and functions of the device 10. It will be appreciated that data can be stored in other additional memory banks (not illustrated) and that the memory banks can be of any suitable types, such as read-only memory, read-write memory, etc.

The device 10 further includes a telephone function 45. The telephone function is configured for carrying out the various functions required for the device to be used as a telephone and receive incoming call and/or make outgoing calls. The mobile telephone 10 includes a conventional telephony application call circuitry that enables the mobile telephone 10 to establish a call, transmit and/or receive E-mail messages, and/or exchange signals with a called/calling device, typically another mobile telephone or landline telephone. However, the called/calling device need not be another telephone, but may be some other device such as an Internet web server, E-mail server, content providing server, etc.

The device 10 is shown as including a camera function 55. The camera function includes circuitry for allowing the device 10 to capture and process images as still pictures and/or as video images using the camera hardware 70.

Mobile telephone 10 includes a variety of camera hardware 70 suitable to carry out aspects of the present invention. The camera hardware 70 may include any suitable hardware for obtaining or capturing a photograph, for example, a camera lens, a flash element, as well as a charge-coupled device (CCD) array or other image capture device, an image processing circuit, and the like. The camera lens serves to image an object or objects to be photographed onto the CCD array. Captured images received by the CCD are input to an image processing circuit, which processes the images under the control of the camera functions 55 so that photographs taken during camera operation are processed and, image files corresponding to the pictures may be stored in memory 44, for example.

When wishing to take a picture with the mobile telephone 10, a user presses a button or other suitable mechanism to initiate the camera circuitry 70 and/or camera function 55. The control circuit processes the signal generated from the user pressing the appropriate buttons. The user is then able to take a photograph and/or video clip in a conventional manner. In this example, the image received by the CCD sensor may be provided to the display 14 via the camera function 55 so as to function as an electronic viewfinder.

As shown in FIG. 2, the device 10 also includes an audio recording 65 application that allows the device to record audio signals received by the device. The audio signals may be audio signals received by the device through the radio circuit during a telephone call being conducted with the device or received through the microphone when the device is used as a recording device. The audio signals may be stored as audio data in one or more audio data files.

The device 10 may include a contact directory 60 for storing a plurality of contact records. Each contact record may include any desirable information related to the contact including traditional contact fields such as the contact's name, telephone number(s), e-mail address(es), business or street addresses, birth date, anniversary date, etc. The contact directory may also serve its traditional purpose of providing a network address (e.g., telephone number, e-mail address, text address, etc.) associated with the person in the contact record to enable any of the telephone application or messaging application to initiate a communication session with the network address via the network communication system.

The contact record may also include a call line identification photograph, which may be, for example, a facial image of the contact. The telephone functionality 45 may drive a user interface to display the call line identification photograph when a caller ID signal of an incoming call matches a telephone number in the contact record in which the call line identification record is included.

The device includes a voice identification application 80. The voice identification application is configured to interact with the sound recording function and audiovisual content. As will be discussed further below, the voice identification application may also be configured to interact with the contact directory 60 and the control records contained therein. The voice identification application may be embodied as executable code that is resident in and executed by the device 10. In one embodiment, the voice identification application 80 may be a program stored on a computer or machine readable medium. The voice identification application 80 may be a stand-alone software application or form a part of a software application that carries out additional tasks related to the device 10.

The voice identification application 80 is configured to perform and execute various functions suitable for carrying out aspects of the present invention. In one aspect, the voice identification application 80 is configured to receive audio data obtained by the device during operation of the phone function, during operation of the sound recording function, or from an audio data file stored in memory. The voice identification may also be configured to process audio data in a suitable manner in preparation for voice recognition processing. The processing may include filtering, audio processing (e.g., digital signal processing) or extraction, conducting voice recognition function, etc. In conducting voice recognition functions, the voice identification application is also configured to compare audio clips and determine if the voice pattern of one clip matches the voice pattern of another clip. These and other functions of the voice identification application are discussed further below with respect to various aspects of the invention.

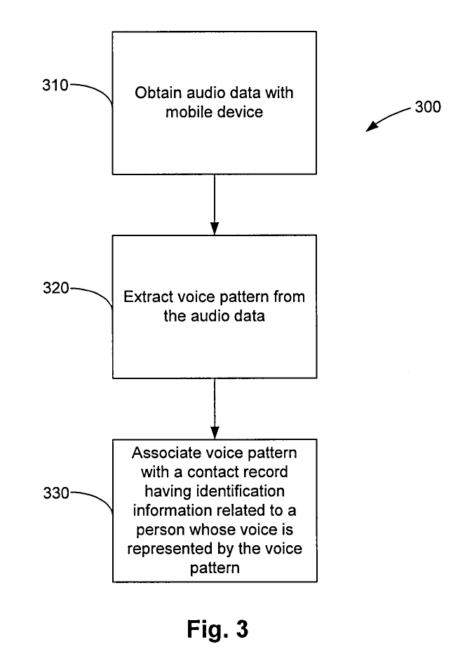

In one aspect, the mobile device and voice identification application allow a voice pattern of a person to be associated with a contact record containing identification information related to the person. In performing this function, the voice identification application may be considered as operating in association mode. FIG. 3 illustrates a general method 300 for associating a voice pattern with a contact record. At functional block 310, the method includes obtaining audio content with the mobile device. At functional block 320, the voice identification application conducts voice recognition functions to produce a voice pattern from the audio content. At functional block 330, the voice identification application associates the voice pattern with a contact record having identification information, e.g., a name, related to the speaker. The audio data may be obtained in any suitable manner using the mobile device.

The audio data may be received from an audio file stored on the device. Such files could be via an e-mail or other message service from another source. The audio data may also be obtained by capturing audio data received by the device during its operation as a recording device or as a telephone. As described above, the mobile device 10 is adapted to store audio content received through the various components including the microphone and radio circuit. The audio content may be received by operating the device to record a voice during a face to face conversation that the user is having with another person or audio produced from another source such as, for example, a television, radio, audio stream, etc. The audio content may also be received as audio data received by the mobile device during a telephone call being carried out with another remote device. In one embodiment, the device may be programmed to record incoming audio data received through the radio circuit (as opposed to audio data associated with a person operating the device, which may be received through the microphone during a call).

After the voice identification application has produced a voice pattern from the audio data, the voice pattern is then associated with a contact record having identification information that is related to the person's whose voice represented by the voice pattern. In one aspect, the user may manually associate the voice pattern with a contact record. The voice identification application may drive the control circuit to display a series of questions or prompts allowing the user to associate the voice pattern with a contact record. For example, the voice identification application may drive the control circuit to display a question asking the user if they want to store the voice pattern with a contact record and then to select a desired contact record with which the voice pattern is to be associated.

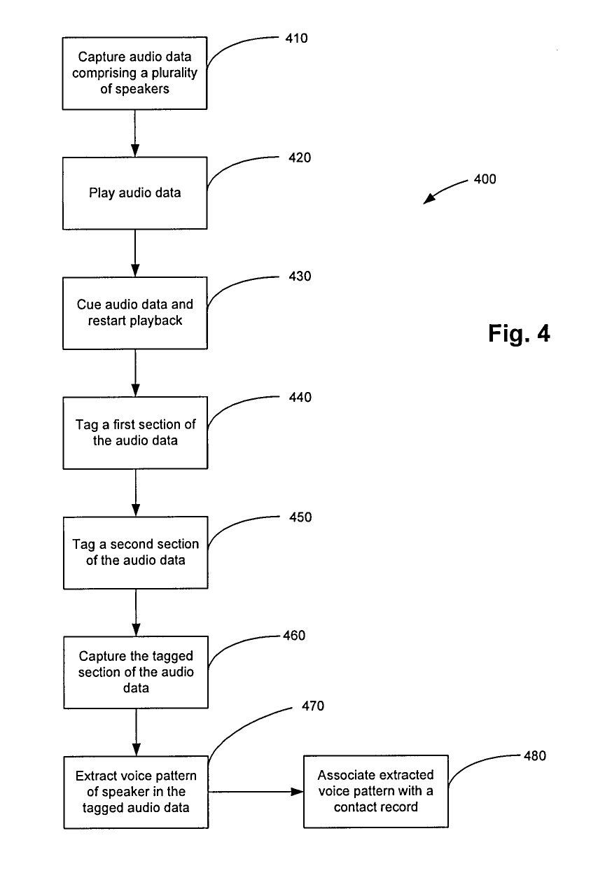

The mobile device and voice identification application may be configured to allow the user to select a section of a stored audio clip from which the voice pattern may be extracted and subsequently associated with a contact record. This may be particularly beneficial in a situation where a user obtains an audio clip containing a plurality of speakers, which may occur, for example, during gatherings, conferences, or meetings, or the like. Referring to FIG. 4, a method 400 for associating a voice pattern with a contact record from a recorded audio data file containing a plurality of speakers is shown. At functional block 410, the device captures audio data containing a plurality of speakers. At functional block 420, the user plays the audio data, and at functional block 430, the user cues the audio and restarts playback of a selected section of the audio data. Cuing the audio data may involve, for example, pausing the audio playback and rewinding the playback. In one embodiment, a user input (e.g., a depression of a key from the keypad 20 or menu option selection) may be used to skip backward a predetermined amount of audio data in terms of time, such as about one second to about ten seconds worth of audio data. In the case of audio content that is streamed to the mobile telephone 10, the playback of the audio data may be controlled using a protocol such as real time streaming protocol (RTSP) to allow the user, to pause, rewind and resume playback of the streamed audio content.

The playback may be resumed so that the phrase may be replayed to the user. During the replaying of the phrase, the phrase may be tagged in functional blocks 440 and 450 to identify the portion of the audio data for use as the audio clip. For instance, user input in the form of a depression of a key from the keypad 22 may serve as a command input to tag the beginning of the clip and a second depression of the key may serve as a command input to tag the end of the clip. In another embodiment, the depression of a button may serve as a command input to tag the beginning of the clip and the release of the button may serve as a command input to tag the end of the clip so that the clip corresponds to the audio content played while the button was depressed. In another embodiment, user voice commands or any other appropriate user input action may be used to command tagging the start and the end of the desired audio clip.

In one embodiment, the tag for the start of the clip may be offset from the time of the corresponding user input to accommodate a lag between playback and user action. For example, the start tag may be positioned relative to the audio content by about a half second to about one second before the point in the content when the user input to tag the beginning of the clip is received. Similarly, the tag for the end of the clip may be offset from the time of the corresponding user input to assist in positioning the entire phrase between the start tag and the end tag, thereby accommodating premature user action. For example, the end tag may be positioned relative to the audio content by about a half second to about one second after the point in the content when the user input to tag the end of the clip is received.

Once the start and the end of the clip have been tagged, the clip may be captured in block 460. For instance, the portion of the audio content between the start tag and the end tag may be extracted, excerpted, sampled or copied to generate the audio clip. In some embodiments, the audio clip may be stored in the form of an audio file.

The captured audio clip may be played back to the user so that the user may confirm that the captured content corresponds to a voice signal pertaining to a person for which the user wants to associate the person's voice pattern with a contact record. If the audio clip does not contain the desired person's voice signal, the user may command the audio clip search function 12 to repeat steps 430 through 460 to generate a new audio clip containing the desired person's voice signal.

At functional block 470, the voice identification application extracts the voice pattern of the voice signal from the tagged section of the audio clip. The user is then prompted to associate the extracted voice pattern with a contact record.

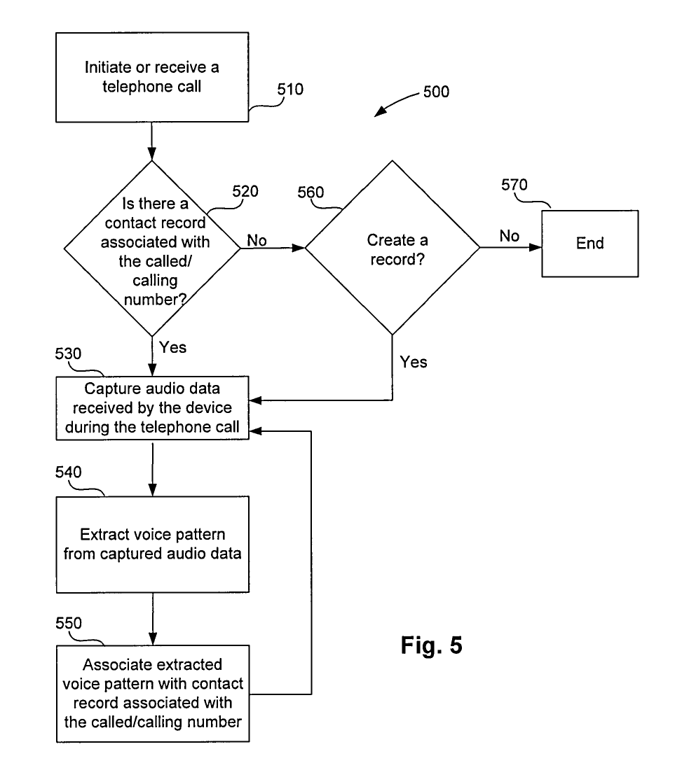

The voice identification application may also be configured to automatically associate a voice pattern with a contact record. Referring to FIG. 5, an exemplary method for automatically associating a voice pattern with a contact record is shown. In method 500, at functional block 510, the mobile device may initiate a telephone call to or may receive a call from another device, such as, for example, a mobile or landline telephone. At functional block 520, the device determines if there is a contact record associated with the number being called (for an outgoing call made by the device) or the number calling the device (for an incoming call to the device). For an outgoing call made by the device, the telephone application 45 may determine that the contact directory 60 contains a contact record that includes the number being called. For an incoming call, the telephone application 45 may recognize a caller ID signal corresponding to a contact record stored in the contact directory 60. Upon determining that the contact directory 60 contains a contact record corresponding to the called/calling number, the processor 42 may drive the telephone application to display on the telephone display selected identification information associated with the identified contact record that is associated with the called/calling number. Such information may include a name, nickname, photograph, etc. associated with the identified contact record.

If the telephone application 45 identifies a contact record in the contact directory 60 associated with the called/calling number, the method may proceed to functional block 530, where the device captures audio data received from the called/calling device during the telephone conversation. The phone may be programmed to automatically activate the sound recording function and capture incoming audio data during a call. Alternatively, the user may be prompted by the phone to select whether incoming audio data are to be captured when a call is received or placed. The audio data may be captured as part of a single audio data file or each block of audio data may be captured as a set of separate audio data files. The audio data files may be temporarily stored in the memory until a voice pattern is extracted therefrom, or the audio data files may be stored for a pre-selected time period or until the user chooses to delete such files.

At functional block 540, the voice identification application extracts a voice pattern from the audio data captured by the device. At functional block 550, the voice identification application associates the extracted voice pattern with the contact record identified by the telephone as being associated with the called/calling number. In one embodiment, the voice identification application will automatically associate the extracted voice pattern(s) with the identified contact record for the called/calling number. In another embodiment, the user may be prompted by a display to select whether they wish to associate a voice pattern with a contact record. User confirmation may be useful in some aspects in the instance where a person other than the person who is identified by the contact record is speaking or there were a plurality of speakers. If the user selects that they do not want to associate the voice pattern with the identified contact record, the user may choose to save the audio data as an audio data and manually associate a voice pattern with a contact record.

If it is determined at functional block 520 that the contact directory does not contain a contact record associated with the called/calling number, the method may proceed to functional block 560, where the telephone application may drive the processor to display a prompt asking the user if they wish to create a contact record. If the user chooses to create a contact record, the process may proceed to functional blocks 530-550. The telephone application may also automatically associate the called/calling number with the newly created contact record (if a corresponding caller ID signal is detected). The user may be required to later associate other identification information with the newly created contact record.

While the method in FIG. 5 was described with respect to the device automatically associating a captured voice pattern with a contact record, it will be appreciated that the user may override the automatic feature and manually determine when to capture the voice signal being received by the device.

In one embodiment, the exemplary methods 400 or 500 may be used to associate a single extracted voice pattern with a contact record. In another embodiment, the methods 400 and 500 may be used to associate a plurality of voice patterns with a contact record. The plurality of voice patterns may be obtained in any suitable manner, including those described above, such as from capturing audio data by recording a “face-to-face” conversation with another person and/or from voice signals received by the device during a telephone conversation. For example, referring to the method shown in FIG. 5, the voice identification application may continuously monitor a telephone call for audio data received during a call and continuously repeat the functions represented by functional blocks 530 through 550 during the telephone call. Thus, as shown in FIG. 5, after associating a voice pattern with a contact record, the process may loop back to functional block 530 and capture additional audio data received by the device during a telephone call. The voice identification may be programmed to recognize when a voice signal is being received and continuously perform the functions represented at functional blocks 530-550 so as to associate a plurality of voice patterns with the contact record.

The number of voice patterns to be associated with a contact record may be selected as desired. For example, the device could be programmed to associate 1, 2, 3, 4, 5, 10, 15, 20, etc., voice patterns with a contact record. The length of time for the recording may be selected as desired. For example, the voice identification application may be programmed to capture an entire segment of an incoming voice signal or to capture a voice pattern of a selected length of time from the segment. Having a plurality of voice patterns may provide voice patterns based on different audio qualities and recording conditions. For example, the audio quality may vary depending on the surrounding conditions of the user and/or the speaker whose voice is being captured. Additionally, face-to-face recordings using the microphone may have a better quality than recordings based on a compressed voice signal received by the device during a telephone call. The sound quality of a voice signal received during a telephone call may change throughout the call; thus, continuously monitoring, capturing the incoming voice signals and extracting voice patterns therefrom may provide an improved voice pattern to be associated with the contact record.

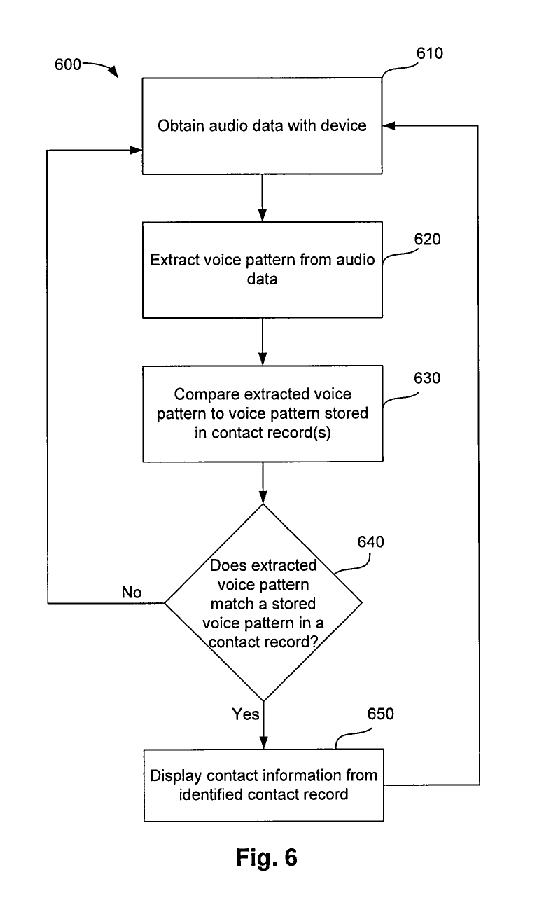

In another aspect, the present invention provides a method for user of the device 10 to identify a speaker. Referring to FIG. 6, a method 600 is shown for identifying a person who is speaking. In this operation, the voice identification application may be said to be operating in identification mode. At functional block 610, a user uses the device 10 to capture audio data of a person speaking. The captured audio data may be of a person to whom the user of the device is speaking (e.g., during a face-to-face conversation or during a telephone conversation conducted with the device) or a person in the vicinity of the user (e.g., a person who may not be speaking directly to the user).

At functional block 620, the voice identification application extracts a voice pattern from the captured audio data. This may be automatic or may be performed after a user selects an audio clip such as previously described with respect to the association mode.

At functional block 630, the voice identification application searches the contact records in the contact directory 60 and compares the extracted voice pattern from the audio data to the voice patterns stored in the contact records.

At functional block 640, the voice identification application determines if the extracted voice pattern matches a voice pattern associated with one of the contact records. If the voice identification application finds a stored voice pattern associated with a contact record that is deemed to be a sufficient match to the extracted voice pattern, the method proceeds to functional block 650, and the voice identification application drives the processor to display at least some of the contact information associated with the contact record having a matching voice pattern. Desirably, the identification information being displayed will include a name. In this way, the user is able to identify the name of speaker of interest to them. For example, the user of a device in accordance with the present invention may be able to identify or obtain the name of a person with whom they are having a face-to-face conversation but whose name they have forgotten or cannot recall. In another example, a user may receive an incoming call on their device but not be aware of who is calling because the calling number is blocked or listed as private. If the user cannot identify or remember the speaker's voice, the method allows the device to determine if the incoming voice signal/pattern matches a voice pattern stored in a contact record and, thus, provide the user with identification information about the speaker.

Whether a voice pattern captured/obtained for identification matches a stored voice pattern may be based on pre-defined conditions defining what constitutes a match. These conditions may be based on the sound qualities/parameters contained in the voice patterns and evaluated by the voice identification application. Various correlation techniques or weighting techniques may be used to compare voice patterns and the voice identification application may be programmed to consider voice patterns having parameters within a certain threshold or tolerance level as being a match.

The identification mode of the voice identification application may be operated in a user controlled mode or a continuous mode. In the user control mode, the user may obtain audio data containing a voice signal of a speaker of interest, select the voice identification application to be operated in an identification mode, and then request that the voice identification application compare one or more voice patterns from the audio data with the voice patterns in the contact records. This may occur in any suitable manner including the user selecting an entire audio clip to evaluate or by tagging a selected portion of the audio clip.

In another embodiment, the voice identification application may be selected to operate in a continuous identification mode. In a continuous identification mode, the voice identification application may constantly monitor audio signals received by the device (whether through the microphone or through the radio circuit such as during a telephone call) and perform the operations illustrated in functional blocks 610-640 of FIG. 6. Referring to FIG. 6, if, at functional block 640, the voice identification application does not identify a contact record containing a voice pattern that matches the voice pattern from an incoming sound signal during a conversation, the method may loop back to functional block 620 and extract another voice pattern from updated or new audio data received by the device. As also shown in FIG. 6, even in a situation where the voice identification application finds a contact record having a matching voice pattern and displays the ID of the current speaker, the method may still loop back from functional block 650 to functional block 610 when a new audio data is received by the device and the functions at functional blocks 610-640 (and optionally block 650) may be repeated. In this way, the method allows the device to constantly display the ID of the current speaker. This may be useful to a person during a conversation with more than one person such as at a gathering with more than one other person, a business meeting, a telephone or video conference, or the like.

In another embodiment, the device may be programmed such that other biometric data may be used to improve the accuracy of detecting the ID of a speaker. For example, the device may include a face recognition program. In addition to capturing a voice signal of a user, the device may be used to capture an image of a speaker. The face recognition program may compare the captured facial image to facial images associated with the contact records and determine if the captured facial image matches a stored facial image (which may or may not be associated with a contact record). The voice identification application may then compare the contact record identified by the face recognition program to the contact record identified by the voice identification application. If the contact records identified by the respective programs are the same, the voice identification application may drive the processor to display identification information from the contact record. The user may capture an image of a speaker and request that the face recognition program identify the image from a contact record. Alternatively, the device may be operated in a video mode and the face recognition program may be configured to determine if an object in the video image is speaking and to automatically capture a facial of the object. The photograph management application may also identify facial images not associated with a contact record, but stored in a different location and which have metadata associated therewith that identifies the facial image. The above is merely an example of one possible biometric parameter that may be used to verify or improve the accuracy of the voice identification application.

While the association mode and the identification mode have been separately described, it will be appreciated that the voice identification application may be configured to operate in both the association mode and identification mode at the same or substantially the same time.

In a non-limiting example of the voice identification application operating in both modes when an incoming call is received, the voice identification application may recognize that the contact record associated with the calling number already has a voice pattern associated therewith. The voice identification application may then obtain a voice pattern of a speaker from the incoming call and compare the obtained voice pattern to the stored voice pattern associated with the contact record identifying the calling number. If the voice identification application determines that the obtained voice pattern matches the stored voice pattern, the voice identification may associate the obtained voice pattern with the contact record. This may occur automatically, and the obtained voice pattern may be stored along with the previously stored voice pattern or may replace the previously stored voice pattern. Alternatively, the voice identification application may drive the display to request user input as to whether the newly obtained voice pattern(s) should be stored with the contact record and/or if they should replace the previously stored voice pattern.

If the voice identification application determines that the voice pattern obtained during the call does not correspond to the voice pattern currently associated with the contact record, the voice identification application may drive the user interface to display a notice indicating that the obtained voice pattern(s) does not match the stored voice pattern. The display may then prompt a user to select whether the obtained voice pattern(s) should replace the previously stored voice pattern(s) associated with the contact record. Prior to such notice or request, upon determining that the obtained voice pattern(s) does not match the voice pattern(s) of the contact record associated with the calling number, the voice identification application may search other contact records to see if the obtained voice pattern matches a voice pattern associated with another contact record. If the voice identification application identifies another contact record (other than the contact record associated with the calling number) as having a stored voice pattern that matches the voice pattern obtained during the call, the voice identification application may (i) drive the device to display identification information associated with the contact record having a matching voice pattern, and/or (ii) (with or without user confirmation) associate the obtained voice patters with a contact record having a stored voice pattern that matches the obtained voice pattern.

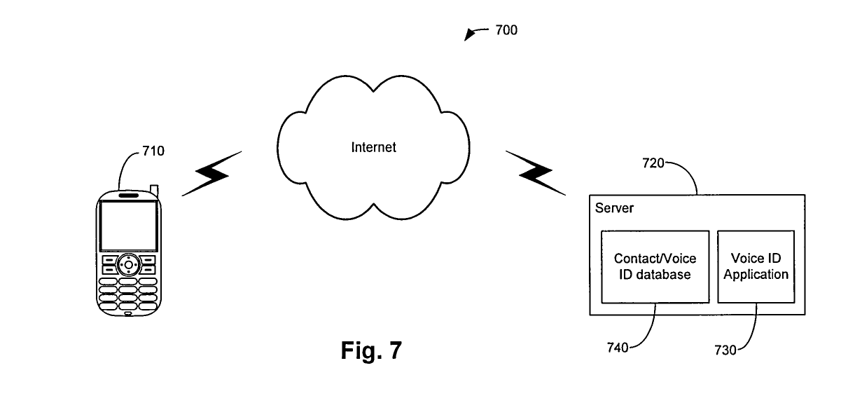

While the foregoing has been described with reference to a mobile device having contact records stored thereon, it will be appreciated that the contact records need not be stored locally on the device but may be stored on a remote server. Referring to FIG. 7, the methods described above may be carried out in a general network or Internet environment 700. In the environment 700, the device 710 captures audio data from a speaker. The device 710 sends the audio data (or voice pattern extracted from the audio data) to a server 720, which contains a voice identification application 730 and a contact directory or voice ID database 740 containing a plurality of contact/ID records having voice patterns associated therewith. The voice identification application 730 receives the voice signal or voice pattern from the device 710 and determines if it matches a voice pattern associated with a contact/ID record stored in the database 740. If a match is found, the server sends the identification information associated with the identified contact/ID to the device 710.

The contact/ID records stored in the database 730 on the server 720 may be contact records personal to the user or may include a database of voice patterns for celebrities, e.g., actors, actresses, TV personalities, sports personalities, politicians, etc. Such a system may be beneficial, for example, for a person who is trying to identify an actor they see on television, but whose name they can not remember. The person may use the device to obtain an audio clip form the television show, send the voice clip to the server 720, where the voice application determines the identification of the actor from the database 730.

A person having skill in the art of programming will, in view of the description provided herein, be able to ascertain and program an electronic device or provide a system to carry out the functions described herein with respect to a photograph management application, a facial identification application, and other application programs. Accordingly, details as to specific programming code have been left out for the sake of brevity. Also, while the various applications are carried out in memory of the respective electronic device 10, it will be appreciated that such functions could also be carried out via dedicated hardware, firmware, software, or combinations of two or more thereof without departing from the scope of the present invention.

Further, the various application, including the voice identification application, may have been described separately as a matter of convenience in describing various aspects of the invention. It will be appreciated, however, that the voice identification application need not be a stand alone application and that the logic associated with the various functions and operations of the voice identification application may be integrated with other applications, such as, for example, logic associated with the phone functionality/voice caller handling functionality, etc.

Additionally, while the various figures may show a particular order of executing functional logic blocks, the order of execution of the blocks may be changed relative to the order shown. Also, two or more blocks shown in succession may be executed concurrently or with partial concurrence. Certain blocks may also be omitted. In addition, any number of commands, state variables, semaphores, or messages may be added to the logical flow for purposes of enhanced utility, accounting, performance, measurement, troubleshooting and the like. It is understood that all such variations are within the scope of the present invention

Although the invention has been shown and described with respect to certain exemplary embodiments, it is understood that equivalents and modifications will occur to others skilled in the art upon the reading and understanding of the specification. The present invention includes all such equivalents and modifications, and is limited only by the scope of the following claims.

What is claimed is:

1. A method of operating a mobile device to obtain and associate audio data with a contact record, the method comprising:
obtaining audio data containing a voice signal;
extracting a voice pattern from the audio data; and
associating the voice pattern with a contact record, the contact record including identification information identifying a person.

2. The method of claim 1, wherein the identification information includes a person's name.

3. The method of claim 1, wherein obtaining the audio data comprises operating the device to record a person speaking.

4. The method of claim 1, wherein the mobile device comprises a telephone application for placing and receiving telephone calls, and obtaining the audio comprises operating the device to record audio data that is received by the device during a telephone call.

5. The method of claim 4, wherein a contact record identifying a contact associated with the telephone number called by or calling the device is activated during the telephone call, and the extracted voice pattern is automatically associated with the contact record.

6. The method of claim 1, wherein the method comprises a user tagging a segment of the audio data to create an audio clip, and a voice pattern is extracted from the audio clip.

7. The method of claim 1, wherein associating the voice pattern with a contact record comprises user selection of a contact record and user input directing the device to associate the voice pattern with the selected identification file.

8. A mobile device comprising:
a contact directory storing a plurality of contact records, each contact record including identification information relating to a person; and
a voice identification application, the voice identification application, when executed, causes the device to extract a voice pattern from audio data and associate the voice pattern with a contact record.

9. The mobile device of claim 8 comprising:
a network communication system;
a user interface; and
a telephone application for placing and receiving telephone calls via the network communication system, wherein the device records audio data received by the device during a telephone call and the voice identification application extracts a voice pattern from the recorded audio data.

10. The mobile device of claim 9, wherein the telephone application drives the user interface to display a contact record when a caller ID signal of an incoming or outgoing call matches a telephone number in the contact record, and the voice identification application (i) drives the user interface to request user input to associate the extracted voice pattern with the contact record, or (ii) automatically associates the voice pattern with the contact record.

11. The mobile device of claim 8, wherein a contact record has a plurality of voice patterns associated therewith.

12. The mobile device of claim 8, wherein the voice identification application extracts a voice pattern from a user selected segment of audio data defining an audio clip.

13. A method of operating a mobile device to identify a speaker comprising:
obtaining audio data containing a voice signal;
extracting a voice pattern from the audio data;
comparing the extracted voice pattern from the audio data to voice patterns associated with contact records stored in a contact directory, each contact record including identification information identifying a person;
identifying a contact record having a voice pattern associated therewith that matches the voice pattern extracted from the obtained audio data; and
displaying, on a display of the mobile device, identification information associated with the identified contact record.

14. The method of claim 13, wherein the mobile device is a mobile telephone.

15. The method of claim 13, wherein the contact directory is stored on the mobile device.

16. The method of claim 13, wherein the contact directory is stored on a remote directory server.

17. The method of claim 13, wherein obtaining audio data comprises continuously capturing audio data received by the device, and the displaying operation comprises continuously updating the display with identification information indicative of a current speaker.

18. A mobile device comprising:
a sound signal processing circuit for receiving and playing audio data;
a voice identification application that executes logic including code that:
extracts a voice pattern from audio data;
accesses a contact directory storing a plurality of contact records, each contact record including identification information identifying with a person, the identification information including a voice pattern and a name of the person;
identify a contact record from the contact directory having a voice pattern that matches a voice pattern of the audio data; and
drive the user interface to display at least a portion of the identification information from the selected contact record.

19. The mobile device of claim 18, wherein the device is a mobile telephone.

20. The mobile device of claim 18, wherein the voice identification application is operated in a continuous mode, and operates to continuously update the display to display identification information indicative of a current speaker.
